(19) United States
(12) Patent Application Publication
(10) Pub. No.: US 2020/0366023 A1
(43) Pub. Date: Nov. 19, 2020

(54) CONTACT INDICATOR FOR ELECTRICAL CONNECTION BASE, CONNECTION BASE EQUIPPED WITH SUCH AN INDICATOR, AND ASSEMBLY COMPRISING AT LEAST ONE CONNECTION BASE AND AT LEAST ONE SUCH INDICATOR

(71) Applicant: MARECHAL ELECTRIC, Saint-Maurice (FR)

(72) Inventor: Francis J ZAGROUN, Neuilly-Sur-Seine (FR)

(21) Appl. No.: 16/961,384

(22) PCT Filed: Jan. 10, 2019
(86) PCT No.: PCT/FR2019/050045

§ 371 Date: Jul. 10, 2020

(30) Foreign Application Priority Data
Jan. 12, 2018 (FR) 1850264

(51) Int. Cl. H01R 13/46; G09F 3/02; G09F 23/00

(52) U.S. Cl. CPC H01R 13/465; G09F 23/00; G09F 3/02

(57) ABSTRACT

A contact indicator for an electrical connection base, comprises a plurality of distinct marks intended to differentiate different contacts of an electrical connection base, and an indexing device allowing a single mounting position on the electrical connection base.

### TECHNICAL FIELD

The present disclosure relates to a contact indicator for an electrical connection base, an electrical connection base equipped with such an indicator, as well as an assembly comprising at least one electrical connection base and at least such an indicator. The electrical connection base can be a socket-outlet or a plug.

A socket-outlet forms a female portion that may belong to a power connection (where the socket-outlet is generally secured to a wall, a casing or the equivalent), to an extension cord, or to a connector (where the socket-outlet generally forms part of a socket), while a plug forms a male portion that may belong to a power connection (where the plug generally forms part of the movable connection), to an extension cord, or to a connector (where the plug is generally secured to an appliance or the equivalent).

In general manner, a socket comprises a socket-outlet and a handle or cap secured to said socket-outlet; a movable connection comprises a plug and a handle or cap secured to said plug; an extension cord is an assembly comprising a socket and a movable connection; a power connection is an assembly comprising a socket-outlet and a plug; and a connector is an assembly comprising a socket and a plug. The handle or cap may be incorporated with the socket-outlet or with the plug, in which circumstance said socket-outlet or plug also forms a socket or a movable connection.

### TECHNICAL BACKGROUND

Generally, electrical connection bases, particularly for power electrical currents, have marks allowing identification of the contacts of the base, this in order to avoid any erroneous assembly of the wires. In fact, erroneous assembly of this kind can lead to an occasionally serious accident. One solution consists of supplying a plurality of distinct marks directly on the base, for example by painting, to differentiate each contact. Such an operation is laborious, costly and irreversible. Moreover, standards differing from one country to another, the base must be painted differently depending on the country in which it will be used, which generates constraints of manufacture, of stock management, and excess costs. Therefore, there exists a need in this respect.

### Presentation

The present disclosure relates to a contact indicator for an electrical connection base.

An embodiment relates to a contact indicator of an electrical connection base, comprising a plurality of distinct marks intended to differentiate different contacts of an electrical connection base, and an indexing device allowing a single mounting position on the electrical connection base.

Hereafter, and unless otherwise indicated, what is meant by “indicator” is “contact indicator” and by “base” is meant an “electrical connection base.”

It is understood that the indicator is a part distinct from the base, and that it is configured to be mounted on a base. The indicator is equipped with an asymmetrical indexing device configured to cooperate with a complementary indexing device of a base, so as to be able to be mounted on this base in a single position. In other words, the indicator can only be mounted in this single position on a given base. However, the indicator can for example be mounted in another single position, on another given base, but not necessarily.

The indexing device may comprise a single element, or several distinct elements.

Thanks to the indexing device, the indicator is a chiral (or with chiral geometry) part, i.e. a part which cannot be superimposed on its image in a mirror. It thus ensures a single mounting position on the base.

The marks borne by the indicator allow identifying the position of each contact within the base when the indicator is mounted on the base, this independently of the internal electrical configuration of the base (i.e. the “cogging” for a person skilled in the art). For example, when the indicator is mounted on the base, each mark is positioned in proximity to, or adjacent to, a different wire passage opening for mounting a wire on a wire clamp, said wire clamp being connected to a contact of the base.

The marks may of course be a color zone, an inscription, a letter, a number, a symbol, any other element allowing differentiation between the different marks, or a combination of these elements. The indicator comprises at least two distinct marks. According to one variant, all the marks are different from one another, but not necessarily. For example, two (or more) marks positioned at distinct locations may be similar.

Such an indicator is a part that is easy to manufacture, can be easily mounted without risk of error on an electrical connection base thanks to the indexing device. For example, several series of indicators may be produced, each series being suited to one country. Thus the same base can easily be adapted to the requirements of different countries, depending on the indicator that is mounted on it. It is therefore possible to standardize the production of the base, and simply produce different indicators, an indicator being a much less costly part and easier to produce than a base. Manufacturing, stock management constraints and the associated costs are therefore considerably reduced relative to the bases of the prior art.

In some embodiments, the indicator comprises a plate, a first side of the plate having a first set of distinct marks while a second side of the plate, opposite to the first side of the plate, has a second set of distinct marks corresponding to the first set of distinct marks, the first set being configured to differentiate the contacts of a first electrical connection base while the second set is configured to differentiate the contacts of a second electrical connection base, complementary to the first electrical connection base.

Naturally, what is meant by the “sides” of the plate are the main sides of the plate having the greatest surface area, and not the edges of the plate.

According to a first variant, the plate is opaque, and distinct marks are present on each side of the plate, all the marks on the same side of the plate forming a set of marks. According to a second variant, the plate is transparent, thanks to which the same marks are visible on both sides of the plate. The indicator is asymmetrical; it is considered, within the meaning of the present disclosure, that the rendition of the marks on the first side forma a first set of marks, while the rendition of the marks on the second side forms a second set of marks, distinct from the first set of marks. This second variant facilitates the manufacture of the indicator and allows reducing the costs of manufacture. In fact, the plate being transparent, it is possible for example to form marks on a single side of the plate, and not on the other. According to one other example, the marks may be distinct inserts buried in the mass of the plate of transparent material. Of course, what is meant by “transparent” is transparent at least to visible light, so that the marks are visible on both sides of the plate.

It is understood that the first base is a socket outlet or a connection base while the second base is respectively the corresponding plug or socket outlet, so that the first base and the second base form together an electrical connection. The first set of marks allows differentiating the contacts of the first base while the second set of marks allows differentiating the contacts of the second base. Just as the second base is a base corresponding to the first base (i.e. they can be connected to one another to accomplish an electrical connection), the second set of marks corresponds to the first set of marks (they allow differentiating the respective contacts which are configured to be put into contact with one another to accomplish an electrical connection). In other words, the first set and the second set have the same marks, for example with a different arrangement, but not necessarily.

The indicator therefore has an indexing device and two sets of marks. Thanks to the indexing device, the indicator can be mounted in a single position on the first base and in a second single position on the second base, the single second position being different from the single first position. When the indicator is mounted on the first base in the single first position, the first side of the indicator is exposed while the second side is masked, and only the first set of marks is visible. Likewise, when the indicator is mounted on the second base in the single second position, the second side of the indicator is exposed while the first side is masked, and only the second set of marks is visible.

Thus the same indicator is usable for both bases of the same electrical connection. It is thus possible to standardize the manufacture of the indicator, which allow reducing the constraints of manufacture, of stock management, and the associated costs.

In some embodiments, the plate is annular and comprises a central through hole and a plurality of through holes distributed circumferentially around the central hole, each hole being configured to be aligned with a wire passage opening of the electrical connection base, a single mark being associated with each hole.

In other words, when the indicator is mounted on a base, each hole is aligned with, receives or leads to a wire passage opening of the base for mounting a wire on a wire clamp, said wire clamp being connected to a contact of the base. Of course, the “central” character of the central hole is relative to the holes which are distributed around the central hole. Thus, the central hole is not necessarily positioned in the center of the plate. For example, an asymmetrical distribution of the holes comprising for example an eccentric position of the central hole relative to the center of the plate (or the axis of the base), may form a indexing device.

It is understood that a single mark is associated with each hole, so as to be able to differentiate the different openings of the base when the indicator is mounted on the base.

Such a configuration allows particularly easy and legible differentiation of the contacts, while still being easy to manufacture and mount on the base. Moreover, this configuration is particularly well suited to mounting on two complementary bases, on each respective side of the indicator.

In some embodiments, the indexing device is formed on the edge of the central hole.

For example, the indexing device comprises one or more specific cutouts provided at the edge of the central hole, or one or more protrusions extending from the edge of the central hole.

Such a configuration is simple to manufacture, and allows easy positioning of the indicator relative to the base during its mounting on the base.

In some embodiments, the indexing device allows a first single mounting position on a first electrical connection base and a second single mounting position, distinct from the first single mounting position, on a second electrical connection base complementary to the first electrical connection base.

Thus, the same indicator is usable for both bases of the same electrical connection. It is thus possible to standardize the manufacture of the indicator, which allows reducing the constraints of manufacture, of stock management and the associated costs.

An embodiment also relates to an electrical connection base comprising a contact indicator for an electrical connection base according to any one of the embodiments described in the present disclosure.

In some embodiments, the contact indicator is removable.

This allows easy replacement of the indicator if it is desired to use the base according to another standard or in another country than that corresponding to the indicator already installed. This also allows easy replacement of the indicator, if ever one or more mark(s) undergo(es) damage and it(they) become(s) illegible. Versatility and ease of maintenance of the base is thereby improved.

In some embodiments, the indicator is assembled to an element of the base by snap fitting.

Such an assembly mode has the advantage of being easy to implement and reliable. It may be permanent or reversible, so that the indicator may be permanently fastened within the base (i.e. it cannot be withdrawn without deteriorating the indicator and/or the base), or removable (i.e. it can be withdrawn without damaging either the indicator or the base).

In some embodiments, the base comprises a housing receiving the contact indicator, a complementary indexing device being formed on a wall of the housing and cooperating by complementarity of shape with the indexing device of the contact indicator.

The housing allows more easily fastening the indicator within the base, and protecting it from external attack.

An embodiment also relates to an assembly comprising an electrical connection base and at least one contact indicator for an electrical connection base according to any one of the embodiments described in the present disclosure.

Of course, the indicator may be mounted, or not mounted, on the base. The assembly may for example comprise several different indicators, corresponding to several different standards, and a single base.

In some embodiments, the assembly comprises a first electrical connection base and a second electrical connection base, complementary to the first electrical connection base, and at least one pair of identical indicators. Such an assembly is very versatile and economical.

The pair of indicators allows mating the two bases according to the same standard. For example, the assembly comprises several different pairs of indicators, corresponding to several different standards, so as to be able to mate the two bases according to different standards. Such an assembly is very versatile and economical.

### BRIEF DESCRIPTION OF THE DRAWINGS

The object of the present disclosure and its advantages will be better understood upon reading the detailed description given hereafter of different embodiments given by way of non-limiting examples. This description refers to the appended pages of figures, in which:

FIG. 1 shows an assembly comprising a first base and a second base, each base being equipped with a contact indicator,

FIGS. 2A and 2B each show an exploded perspective view of the assembly of FIG. 1, the bases approaching, and

FIGS. 3A and 3B each show a different face of the indicator of the assembly of FIG. 1.

### DETAILED DESCRIPTION

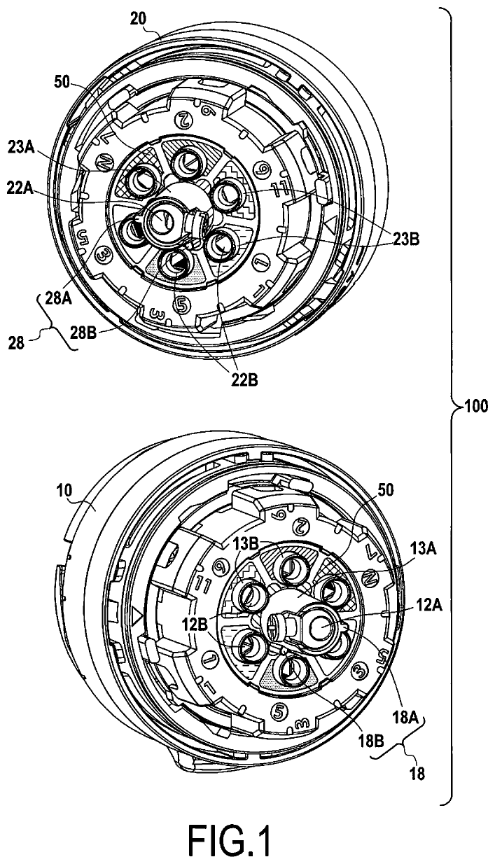

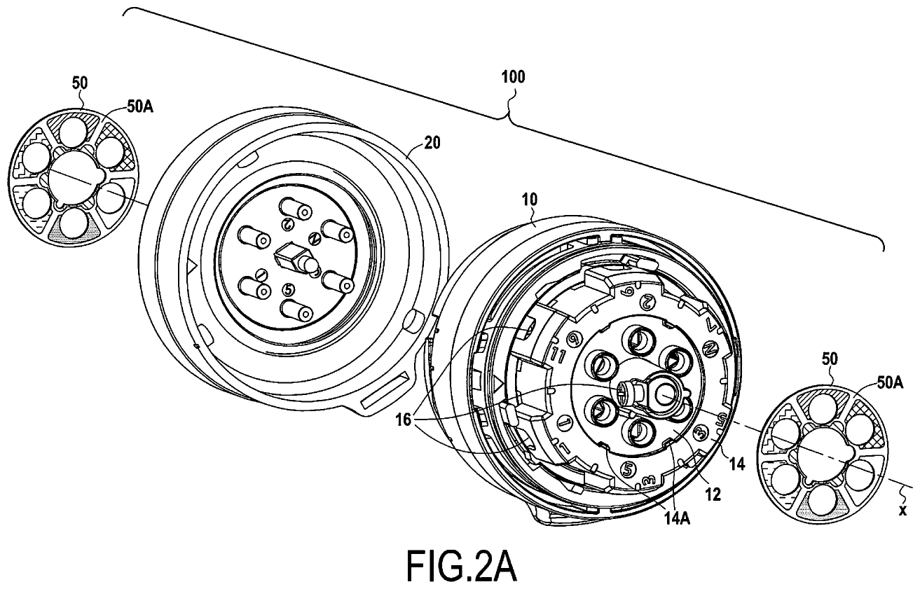

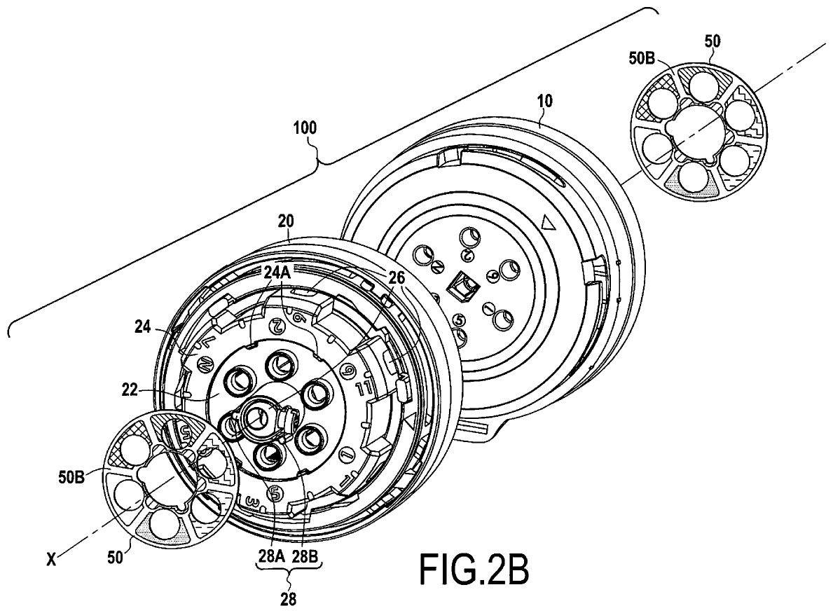

FIG. 1 shows an assembly 100 comprising a first electrical connection base 10 equipped with a contact indicator 50 and a second electrical connection base 20 equipped with the same contact indicator 50. As can be seen in FIGS. 2A and 2B, the bases 10 and 20 are complementary bases, in this example the first base 10 being a socket outlet while the second base 20 is a plug. Of course, according to one variant, the first base could be a plug while the second base would be a socket outlet. In other words, the assembly 100 is an assembly comprising a first electrical connection base, a second electrical connection base, and a pair of identical indicators.

With reference to FIGS. 2A and 2B, the indicators 50 are removable respectively from the base 10 and from the base 20. Each base 10, 20 comprises a housing formed by a concavity 12, 22. In this example, the concavities 12 and 22 are respectively provided in a cover 14, 24 for protecting wire clamps 16, 26. Tabs 14A, 24A allow assembly by snap fitting of the indicators 50 with the bases 10, 20. Of course, the wire clamps 26 are electrically connected to the pins (i.e. the contacts), visible in FIG. 2A, of the second base 20 while the wire clamps 16 are electrically connected to internal contacts, not visible in the figures, of the first base 10, these internal contacts being configured to be connected electrically to the pins of the base 20.

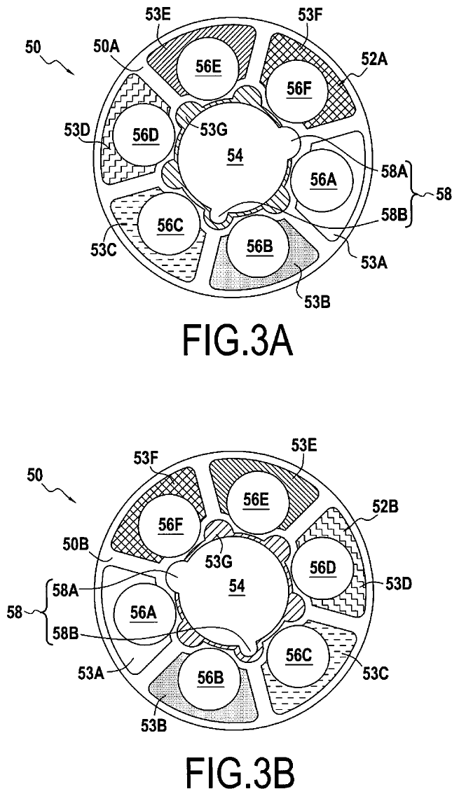

The indicators 50 being identical, a single indicator is described in detail with reference to FIGS. 3A and 3B. In this example, the indicator 50 is a transparent annular plate having a first side 50A and a second side 50B, opposite to the first side 50A. The first side 50A has a first set 52A of distinct marks 53A to 53G while the second side 50B has a second set 52B of distinct marks 53A to 53G, corresponding to the first set of marks 52A. The plate being transparent, the marks are formed on a single side, in this example the first side 50A, and are visible on the second side 50B (and of course on the first side 50A). Of course, a reverse configuration, where the marks are formed on the second side and visible from the first side, is possible. The indicator 50 being asymmetrical, the rendition of the marks 53A to 53G of the first side 50A forms the first set of marks 52A while the rendition of the marks 53A to 53G of the second side 50B forms the second set of marks 52B, distinct from the first set of marks 52A. In this example, the marks are different shading (mark 53A being unshaded), but of course according to one variant the marks may be of a different nature, for example colors, letters, etc. or a combination of these types of marks. In this example, the marks are different, but of course according to one variant, some marks may be identical but positioned at different locations, such as for example the marks 53B and 53F. In this example there are seven marks, but the number of marks could also be different.

The indicator 50 has a central through hole 54, and a plurality or peripheral through holes 56A to 56F distributed circumferentially around the central hole 54. In this example, there are six peripheral holes, but of course, just as with the number of marks, there could be a different number of peripheral holes.

A single mark 53A to 53G is respectively associated with each hole 54, 56A to 56F. In this example, the marks 53A to 53F are respectively associated with the holes 56A to 56F and the mark 56G is associated with the central hole 54. In this example, on each side 50A and 50B, an identical mark is associated with the same hole, which minimizes the risk of error at the time of fastening wires to the base by an installer, but according to one variant, a different mark depending on the side of the indicator could be associated with the same hole.

The rim of the central hole has an indexing device 58, comprising a first cutout 58A and a second cutout 58B. The first cutout 58A and the second cutout 58B are positioned circumferentially so as to avoid any symmetry between the first side 50A and the second side 50B. In this example, the first cutout 58A and the second cutout 58B are different in size and are spaced circumferentially by less than 180° (one hundred eighty degrees of angle), i.e. they are not diametrically opposed. In this example, the cutouts 58A and 58B have a semicircular shape, but could have different shapes, particularly asymmetrical shapes relative to the radial direction (i.e. in this example, the radial direction relative to the geometric center of the central hole 54). Thus, in this example, the cutout 58A has a semicircular shape with a greater diameter while the cutout 58B has a semicircular shape with a smaller diameter and are spaced angularly by 120 (one hundred twenty degrees of angle).

Thanks to this indexing device 58, the indicator 50 is configured to be able to be mounted on a base in only a single position. In fact, the first base 10 has a first complementary indexing device 18, comprising a first axial rib 18A and a second axial rib 18B, configured to cooperate by complementarity of shape with the indexing device 58 of the indicator 50 so that the first side 50A is visible while the second side 50B is masked. It is noted that the axial direction X is the press-fitting direction of the bases 10, 20. The second base 20 has a second indexing device 28, different from the first indexing device 18 and comprising a first axial rib 28A and a second axial rib 28B, configured to cooperate by complementarity of shape with the indexing device 58 of the indicator 50 so that the second side 50B is visible while the first side 50A is masked. In other words, the first cutout 18A can cooperate by complementarity of shape only with the first rib 18A or 28A, while the second cutout 18B can cooperate by complementarity of shape only with the second rib 18B or 28B. The first rib 18A is similar to the first rib 28A while the second rib 18B is similar to the second rib 28B. However, the relative angular placement of the ribs 18A and 18B is inverted relative to the ribs 28A and 28B. Thus the indexing devices 18 and 28 are different so that the mounting positions on the first base 10 and on the second base 20 are unique and different from one another. In other words, the indicator 50 can be mounted only in a single first position on the first base 10, and in a single second position on the second base 20.

The bases 10, 20 each have a central opening 12A, 22A, and peripheral openings 12B, 22B positioned circumferentially around the openings 12A, 12B. These openings allow the passage of the wires of a cable (not shown) to electrically connect the wires of the cable to the wire clamps 16, 26 of the bases 10, 20. In this example, a sleeve 13A, 13B and 23A, 23B extends axially from the housing 12, 22; these sleeves form walls delimiting (partially, in this example) the housing 12, 22. It is noted that the central sleeve 13A, 23A is longer in the axial direction X than the peripheral sleeves 13B, 23B. Moreover, the complementary indexing device 18, 28 is formed at the periphery of the central opening 12A, 22A (i.e. on a wall of the housing 12, 22). More precisely, in this example, the ribs 18A, 18B and 28A, 28B are formed on the external periphery of the central sleeve 13A, 23A. According to one variant, the sleeves 13A, 13B and 23A, 23B are not present and the indexing device 18, 28 is carried by another wall delimiting the housing 12, 22.

To mount the indicator 50 on a base 10 or 20, the central hole 54 is aligned with the central opening 12A or 22A and the peripheral holes 56A to 56F with the peripheral openings 12B or 22B, and the indicator is press-fit around the sleeves 13A, 13B or 23A, 23B until the indicator 50 is received in the housing 12 or 22 and cooperates by snap fitting with the tabs 14A or 24A. Of course, the indexing device 58 being able to cooperate with the complementary indexing device 18 in only a single manner, care is also taken during assembly on the first base 10 to align the indexing device 58 with the indexing device 18. Otherwise it is impossible to mount the indicator 50 on the first base 10. Thanks to the indexing device 58, the sole possible mounting position on the first base 10 is the position in which the first side 50A is visible while the second side 50B is masked. Similarly, the indexing device 58 being able to cooperate with the complementary indexing device 28 in only one way, care is also take during mounting on the second base 20 to align the indexing device 58 with the indexing device 28. Otherwise it is impossible to mount the indicator 50 on the second base 20. Thanks to the indexing device 58, the sole possible mounting position on the second base 20 is the position in which the second side 50B is visible while the first side 50A is masked. Thanks to the indexing device 58, it is thus impossible to mount the indicator 50 in another position from that described above, either on the first base 10 or on the second base 20.

Although the present invention has been described while referring to specific embodiments, it is obvious that modifications and changes can be carried out on these examples without departing from the general scope of the invention as defined by the claims. In particular, individual features of the different embodiments illustrated/mentioned can be combined into additional embodiments. Consequently, the description and the drawings must be considered in an illustrative, rather than a restrictive sense.

1.-12. (canceled)

13. A contact indicator for an electrical connection base, comprising a plurality of distinct marks intended to differentiate different contacts of an electrical connection base for mounting electrical wires on the electrical connection base, and an indexing device allowing a single mounting position on the electrical connection base.

14. The contact indicator according to claim 13, comprising a plate, a first side of the plate having a first set of distinct marks while a second side of the plate, opposite to the first side of the plate, has a second set of distinct marks corresponding to the first set of distinct marks, the first set of distinct marks being configured to differentiate the contacts of a first electrical connection base while the second set of distinct marks is configured to differentiate the contacts of a second electrical connection base, complementary to the first electrical connection base.

15. The contact indicator according to claim 14, wherein the plate is annular and comprises a central through hole and a plurality of through holes distributed circumferentially around the central through hole, each hole being configured to be aligned with a wire passage opening of the electrical connection base, a single mark being associated with each hole.

16. The contact indicator according to claim 15, wherein the indexing device is formed on an edge of the central through hole.

17. The contact indicator according to claim 14, wherein the plate is transparent, thanks to which the same marks are visible on both sides of the plate.

18. The contact indicator according to claim 13, wherein the indexing device allows a first single mounting position on a first electrical connection base and a second single mounting position, distinct from the first single mounting position, on a second electrical connection base complementary to the first electrical connection base.

19. An electrical connection base comprising a contact indicator according to claim 13.

20. The electrical connection base according to claim 19, wherein the contact indicator is removable.

21. The electrical connection base according to claim 19, wherein the contact indicator is assembled to an element of the base by snap fitting.

22. The electrical connection base according to claim 19, comprising a housing receiving the contact indicator, a complementary indexing device being formed on a wall of the housing and cooperating by complementarity of shape with the indexing device of the contact indicator.

23. An assembly comprising at least one electrical connection base and at least one contact indicator according to claim 13.

24. The assembly according to claim 23, comprising a first electrical connection base and a second electrical connection base, complementary to the first electrical connection base, and at least one pair of identical contact indicators.
